(19) United States
(12) Patent Application Publication
(10) Pub. No.: US 2006/0221046 A1
(43) Pub. Date: Oct. 5, 2006

(54) Display device and method of driving display device

(75) Inventors: Ko Sato, Ome-shi (JP); Yoshihiko Ogawa, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/377,439

(22) Filed: Mar. 17, 2006

(30) Foreign Application Priority Data
Mar. 30, 2005 (JP) 2005-098263

(51) Int. Cl. G09G 3/36

(52) U.S. Cl. 345/102

(57) ABSTRACT

A display device has a display drive unit, a light-emitting drive unit, a display unit which displays images in accordance with the display drive signal from the display drive unit, an irradiation unit, a detection unit, and a control unit which compares a displayable bandwidth of the display unit with a bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controls the light-emitting drive signal so as to lower the degree of irradiation of the irradiation unit in accordance with the picture signal and controls the display drive signal so as to improve brightness of image display of the display unit in accordance with the picture signal.

### CROSS-REFERENCE TO RELATED APPLICATIONS

This application is based upon and claims the benefit of priority from Japanese Patent Application No. 2005-098263, filed Mar. 30, 2005, the entire contents of which are incorporated herein by reference.

### BACKGROUND

1. Field

The present invention relates to a display device, and in particular, to a display device and a method of driving a display device, the display device being capable of making the best of a dynamic range of the display device to express gradation by lowering the brightness of back light and in contrast, improving a given picture signal when the picture signal is lower than a predetermined value.

2. Description of the Related Art

Recently, in place of a conventional cathode ray tube (CRT), a liquid crystal display (LCD) unit is popularly used as TV sets and computer displays. In this kind of LCD unit, the liquid crystal itself does not emit light but in the backlight, the liquid crystal is irradiated from behind.

In this kind of patent document 1 (Jpn. Pat. Appln. KOKAI Publication No. 2000-321571), there is indicated a display which can display images on an LCD screen in accordance with a picture signal given, and irradiate the LCD screen from behind by the backlight. In this case, display for each region is achieved in accordance with mean brightness of picture signals by adjusting the backlight brightness for each region in accordance with the mean brightness of the picture signals given.

However, in the prior art of patent document 1, it can be understood that the backlight brightness corresponds to the mean brightness of the picture signals, but there is not definitely indicated how picture signals should be adjusted. Consequently, there has been a problem that it is unclear how the gradation capability of the low region of an image (dark screen) could be improved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of a configuration of a display device (liquid crystal display device) according to one embodiment of the present invention;

FIG. 2 is a graph showing a histogram that indicates one example of a brightness distribution of picture signals supplied to the display device;

FIG. 3 is a graph showing a histogram that indicates one example of a dynamic range of the display device;

FIG. 4 is a block diagram which shows one example of a configuration of the display device (FED unit);

FIG. 5 is a flow chart showing one example of processing operation of the display device;

FIG. 6 is a flow chart showing one example of processing operation of the display device;

FIG. 7 is a flow chart showing one example of processing operation of the display device;

FIG. 8 is a flow chart showing one example of processing operation of the display device;

FIG. 9 is a flow chart showing one example of processing operation of the display device;

FIG. 10 is a flow chart showing one example of processing operation of the display device; and

FIG. 11 is an illustration explaining that the gradation property of the display device is improved.

### DETAILED DESCRIPTION

Various embodiments according to the invention will be described hereinafter with reference to the accompanying drawings. In general, according to one embodiment of the invention, a display device according to one embodiment of the present invention comprises: a display drive unit which generates a display drive signal that corresponds to a picture signal to be supplied; a light-emitting drive unit which generates a light-emitting drive signal that corresponds to the picture signal to be supplied; a display unit which displays images in accordance with the display drive signal from the display drive unit; an irradiation unit which emits light in accordance with the light-emitting drive signal from the light-emitting drive unit and irradiates the display unit from behind; a detection unit which converts a brightness distribution of the picture signal to be supplied into histograms; and a control unit which compares a displayable bandwidth of the display unit with a bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controls the light-emitting drive signal so as to lower the degree of irradiation of the irradiation unit in accordance with the picture signal and controls the display drive signal so as to improve brightness of image display of the display unit in accordance with the picture signal.

Embodiments of the present invention will be described in detail with reference to the accompanying drawings.

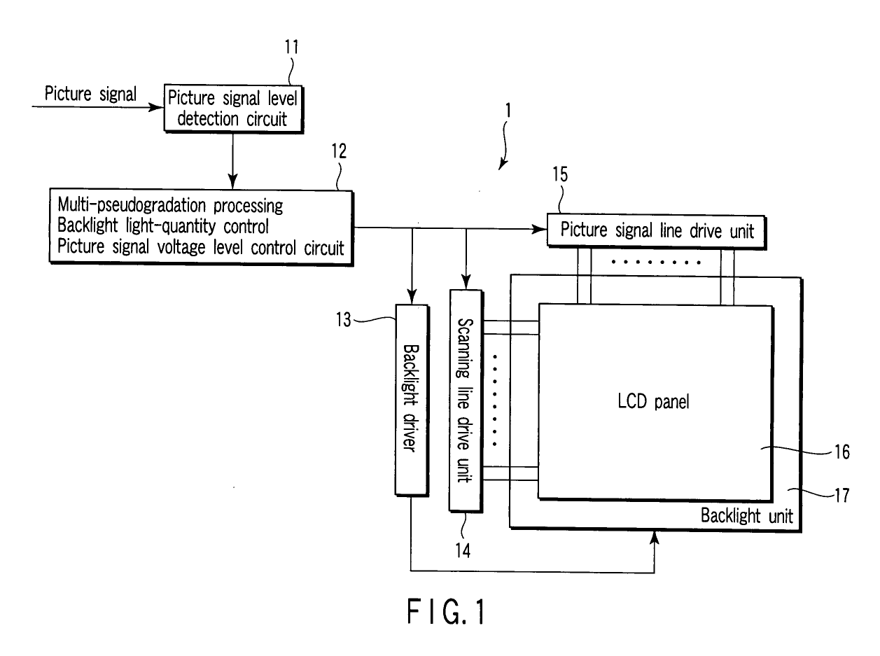

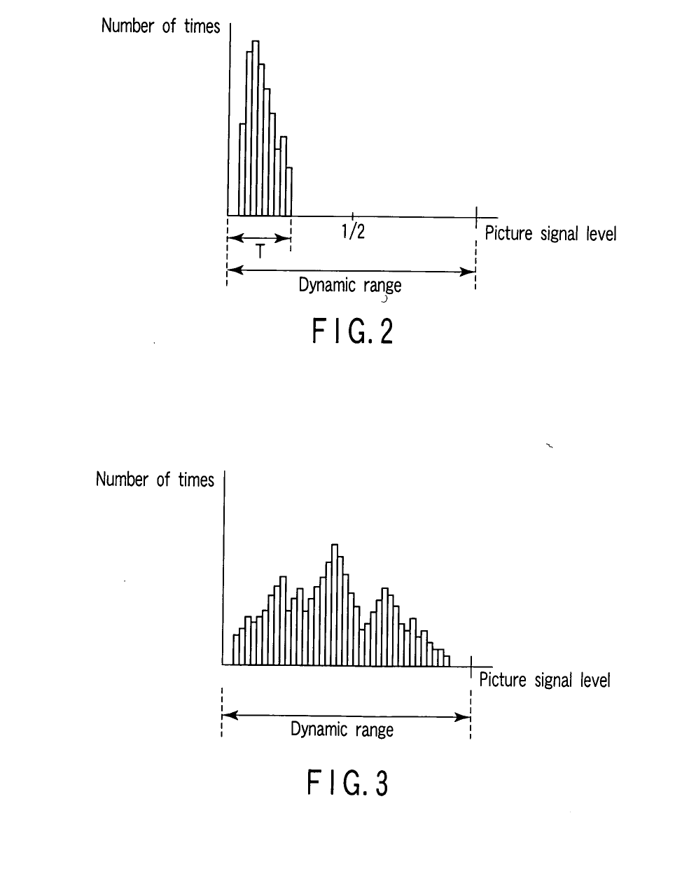

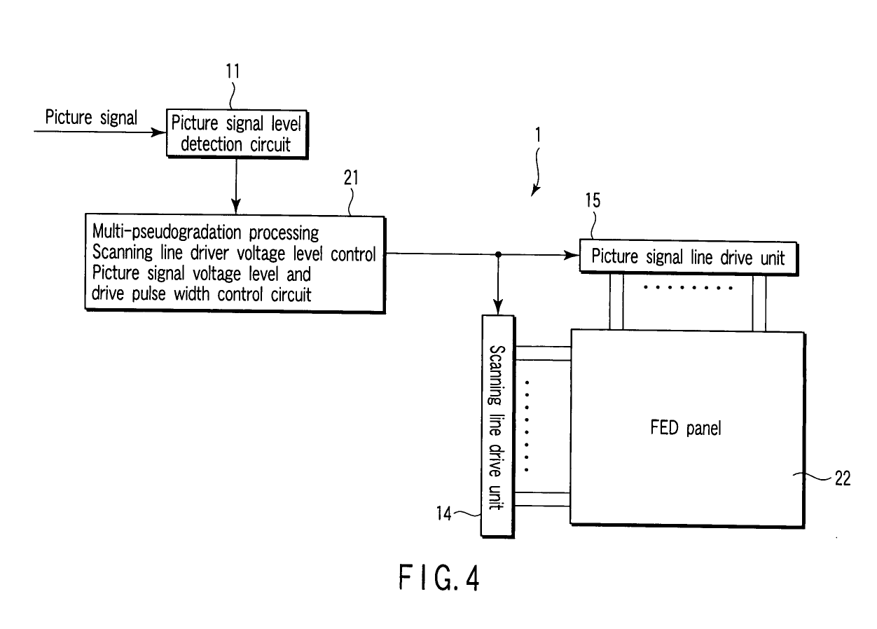

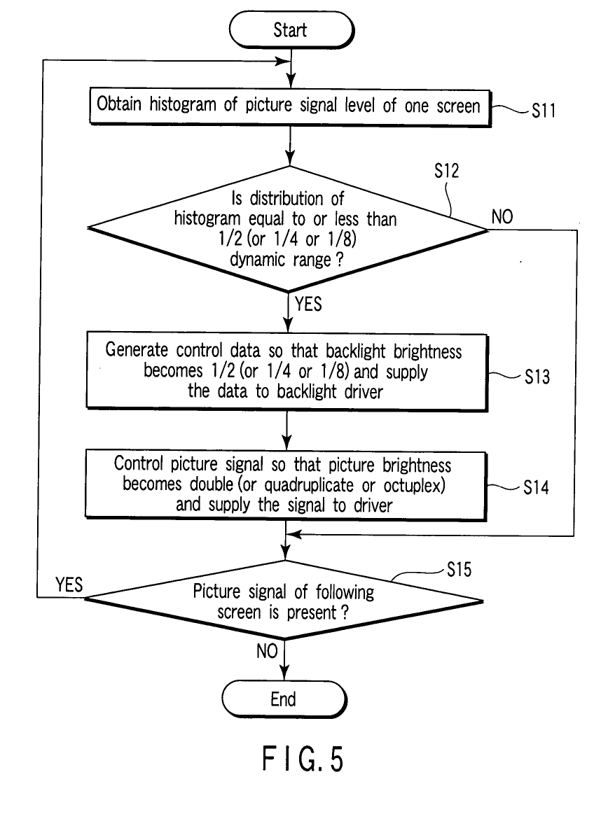

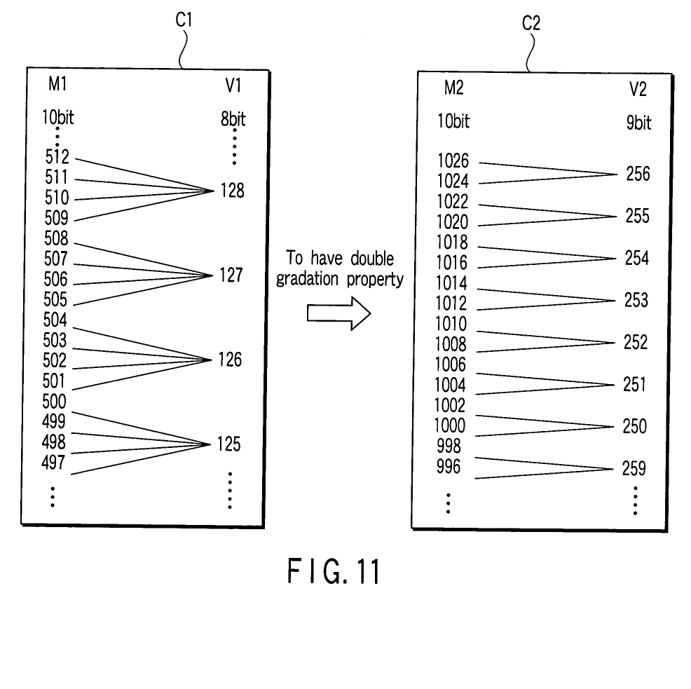

FIG. 1 is a block diagram showing one example of a configuration of a display device (liquid crystal display device) according to one embodiment of the invention. FIG. 2 is a graph showing a histogram that indicates one example of a brightness distribution of picture signals supplied to the display device. FIG. 3 is a graph showing a histogram that indicates one example of a dynamic range of the display device. FIG. 4 is a block diagram showing one example of a configuration of the display device (FED device). FIGS. 5 to 10 are flow charts each showing one example of processing operation of the display device. FIG. 11 is an illustration explaining that the gradation property of the display device is improved.

<Liquid Crystal Display Device According to One Embodiment of the Present Invention>

(Configuration)

A liquid crystal display device according to one embodiment of the invention has a picture signal level detection circuit 11, a control circuit 12, a backlight driver 13, a scan line drive unit 14, a picture signal line drive unit 15, an LCD panel 16, and a backlight unit 17. The picture signal level detection circuit 11 generates a histogram according to picture signals as shown in FIG. 1. The control circuit 12 carries out multi-pseudogradation processing, backlight light quantity control, and picture signal voltage level control. The backlight driver 13 receives the output and supplies light-emitting drive signals to the backlight unit 17. The scan line drive unit 14 supplies scan line signals to the LCD panel 16. The picture signal line drive unit 15 supplies display drive signals to the LCD panel 16. The backlight unit 17 irradiates the LCD panel 16 from behind.

(Basic Operation)

When a histogram distribution of picture signals is equal to or less than a dynamic range of a display screen, the liquid crystal display device 1 according to one embodiment of the present invention lowers backlight brightness and improves display brightness in accordance with the picture signals, thereby improving the display gradation property.

The backlight control of drive signals of the liquid crystal display device 1, one embodiment of the invention, is carried out as follows as shown in the flow chart of FIG. 5. That is, first of all, a histogram of a picture signal level of one screen is obtained in the picture signal level detection circuit 11 (step S11). Now, a method for display control will be described with a case when a signal with a brightness distribution as shown in FIG. 2 is input as a picture signal that correspond to one scan line taken as an example. Herein, it is assumed that the number of bits which picture signals possess is 12 bits and that the number of bits of a voltage value which can be output by a liquid crystal signal voltage driver is 8 bits. In normal time (when brightness distribution covers substantially the entire region of the dynamic range as shown in FIG. 3), of the 12-bit picture signal, low-order-4-bit data is discarded and is converted into an 8-bit signal voltage value.

In the distribution of picture signal data of one scan line shown in FIG. 2, consideration will be made for a case in which a bandwidth T from the minimum brightness level of the brightness distribution posted to the histogram to the maximum brightness level is, for example, equal to or less than ½ the maximum value in the dynamic range of the picture signal. The minimum brightness level used here means the brightness level with the lowest dynamic range in the histogram, and the bandwidth from this brightness level to the maximum brightness level is called into question. Consequently, when the maximum brightness level is markedly high where the whole screen is uniformly bright, the displayable bandwidth from the minimum brightness level to the maximum brightness level becomes extremely wide, and the bandwidth becomes less than ½ the dynamic range, so that the case does not fall under the required conditions. In this specification, the “displayable bandwidth T from the minimum brightness level to the maximum brightness level” shown in FIG. 2 hereinafter is simply expressed as “histogram distribution T.”

In the case where the histogram distribution T is determined to be equal to or less than ½ the maximum value in the dynamic range, the light quantity of a lighting light source for backlight is set to ½ that at the normal display (same as above). At the same time, at the normal time, the lower 4-bit data of the picture signal is discarded, whereas the lower 3-bit data only is discarded to input into the picture signal line drive unit 15. By doing so, the number of gradations which can be expressed in a narrow brightness region in which the picture signal exists becomes practically double, and fine gradation can be reproduced, which has never been expressed when it is displayed without control of the backlight.

FIG. 11 shows the correspondence of signals in such an event, and in signal conversion C1, a picture signal M1 is converted into a voltage value V1. In this example, four signal levels of the picture signal M1 are made equivalent to one voltage value V1. On the other hand, in the case where the histogram distribution T is, for example, ½ the maximum value in the dynamic range of the picture signal, two signal levels of a picture signal M2 are made equivalent to one voltage value V1 in accordance with signal conversion C2. Such signal conversion has led the gradation property to have double value.

The similar correspondence should be achieved when the histogram distribution T is equal to or less than ¼ the maximum value in the dynamic range of the picture signal and is equal to or less than ⅛, and quadruplicate and octuplex improvements, respectively, are expected in gradation property.

That is, as shown in the flow chart of FIG. 5, it is determined whether or not the histogram distribution T is equal to or less than ½ (or ¼ or ⅛) the dynamic range (step S12). In the case where the histogram has such a value, control data in which backlight brightness becomes ½ (or ¼ or ⅛) is generated in the backlight light quantity control circuit 12, and the generated data is supplied to the backlight driver 13 (step S13). In addition, in the picture signal voltage level control circuit 12, control data is generated in such a manner that the picture brightness becomes double (or quadruplicate or octuplex) and supplied to the picture signal line drive unit 15 (step S14). In the case where there is any picture signal of the next screen, processing is repeated from step S11 (step S15). In this way, it is possible to expect double (or quadruplicate or octuplex) improvement of the gradation property as shown in the illustration of FIG. 11.

In the above embodiment, processing is explained for each screen. However, it is not always necessary to take this form but it is preferable that the screen may be divided into 2 regions or 4 regions, and same processing is carried out for each divided screen. In addition, it is preferable to carry out processing with the screen divided into four regions or more.

(Backlight Control Using Correction Table)

Next, backlight control is carried out by using a correction table. That is, the relationship between the brightness of the backlight unit and the brightness of the LCD panel 16 is not always linear as described above, and has a predetermined relation which can be measured and specified. Therefore, a plurality of correction tables are provided which store optimum values as to what kind of the backlight brightness and picture signal voltage level should be achieved when the histogram distribution T is equal to or less than ½ the maximum value in the dynamic range of the picture signal. By using the correction tables, backlight control is carried out.

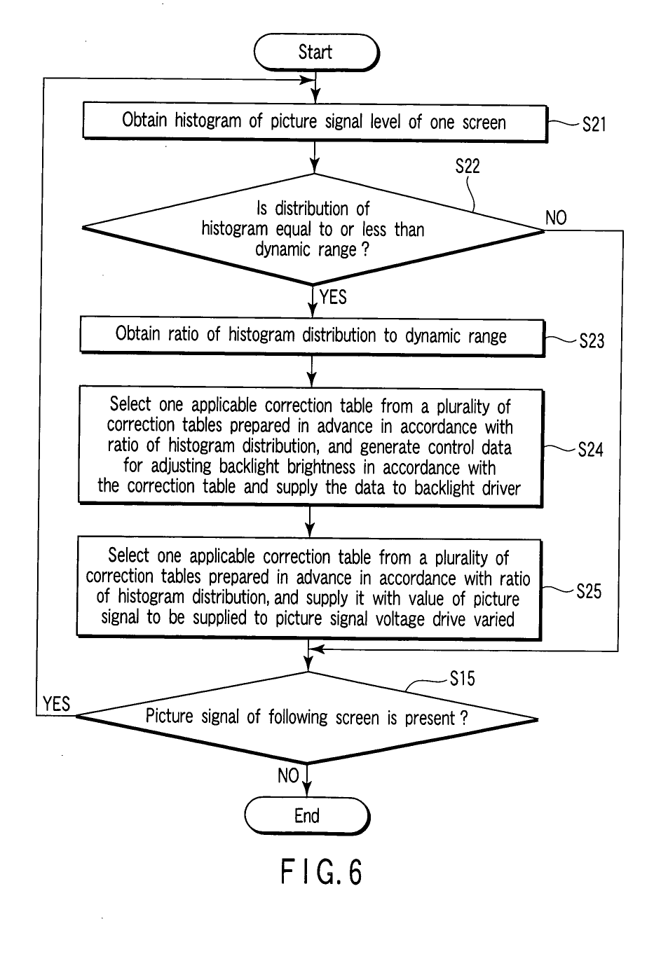

That is, as shown in the flow chart of FIG. 6, it is determined whether or not the histogram distribution T is equal to or less than a predetermined value of the dynamic range, for example, equal to or less than ½ (or ¼ or ⅛) (step S22). Then, the ratio of the histogram distribution T to the dynamic range is obtained (step S23). One applicable correction table is selected from the plurality of correction tables prepared in advance in accordance with the ratio of the histogram distribution, and in accordance with this, control data is generated to adjust the backlight brightness, and supplied to the backlight driver (step S24). Furthermore, in accordance with the ratio of the histogram distribution T, one applicable correction table is selected from the plurality of correction table prepared in advance, and in accordance with this, the value of the picture signal to be supplied to the picture signal voltage driver is changed and supplied (step S25). If there is any picture signal of the next screen, processing is repeated from step S11 (step S15).

In this way, using correction tables prepared in advance enables the intended backlight control to take place even when linearity is not guaranteed, so that the gradation property of image display can be achieved.

(Backlight Control with Indoor Light Quantity Taken into Account)

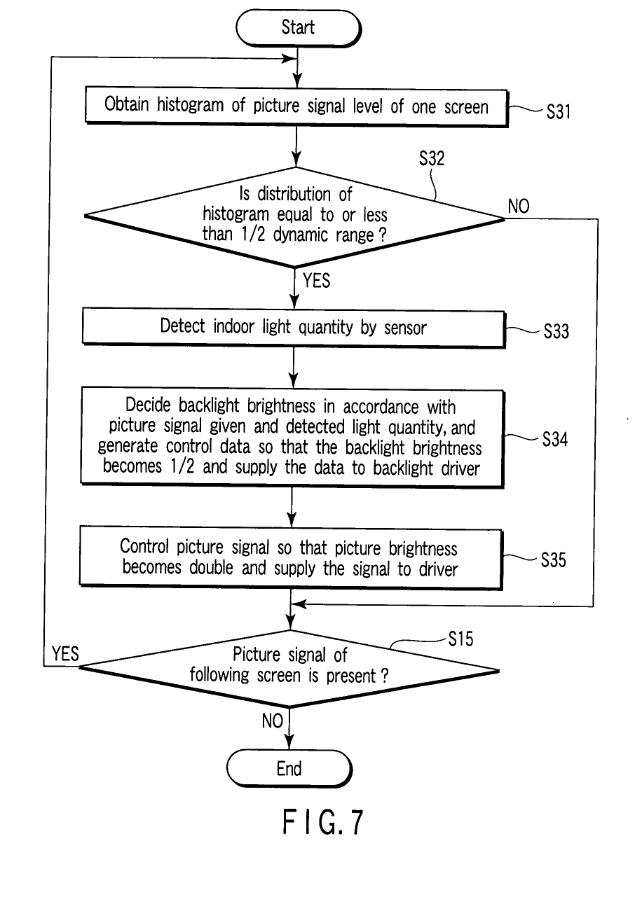

In addition, it is preferable to provide a light quantity sensor (not shown) around the LCD panel 16, to detect an indoor light quantity, and to decide the value of backlight, etc. in consideration of the detected light quantity as shown in the flow chart of FIG. 7. Thereby, it is possible to achieve the gradation property of image display according to one embodiment of the present invention while maintaining the optimum backlight brightness with daytime, nighttime and other indoor light quantities taken into account.

With respect to the description of steps 31 to S35 of the flow chart of FIG. 7, the process of detecting the indoor light quantity of step S33 and the process of deciding backlight brightness reflected to this in step S34 are characteristic, but others are equivalent to each process of the flow chart of FIG. 5. Therefore, detailed description will be omitted.

(Backlight Control with Counter Provided)

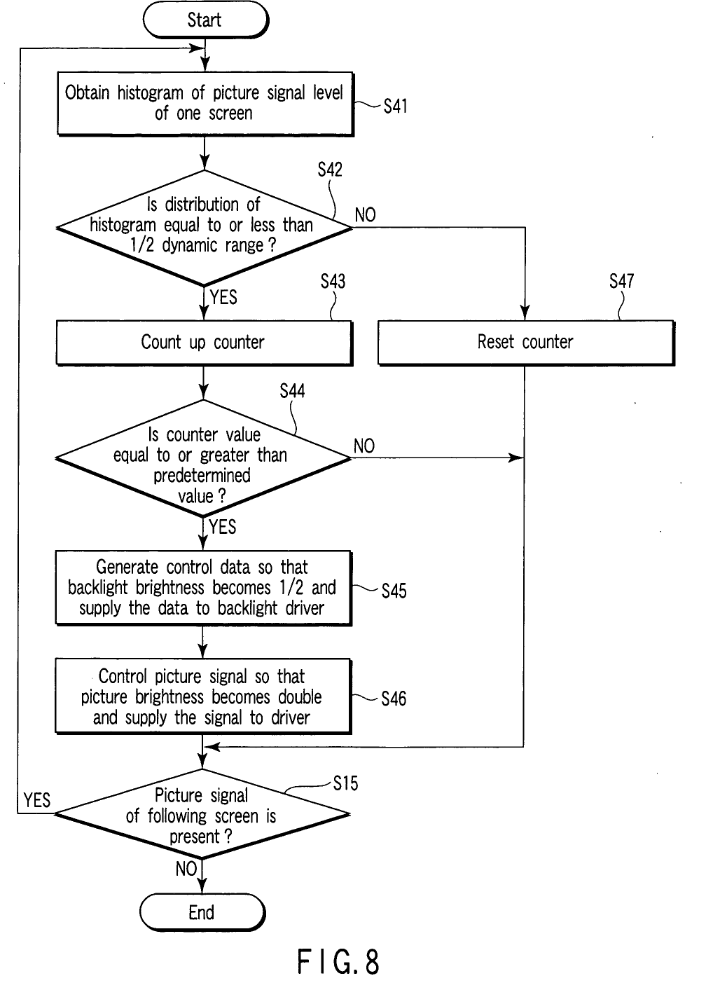

Next, as shown in FIG. 8, it is preferable to count the frequency by a counter when the histogram distribution T becomes equal to or less than the predetermined value of the dynamic range and to actually carry out backlight control when the counter's value reaches zero. By doing this, it is possible to prevent the screen from becoming messy by frequently changing from the conversion mode of the present invention to the normal mode.

That is, as shown in the flow chart of FIG. 8, it is determined whether or not the histogram distribution T is equal to or less than ½ the dynamic range (step S42). In the case where the histogram has such a value, the count expires (step S43). When the counter counts the predetermined value or more (for example, 10 times) (step S44), control data is generated such that the backlight brightness becomes ½ in the backlight light quantity control circuit 12, and the generated data is supplied to the backlight driver 13 (step 43). In addition, in the picture signal voltage level control circuit 12, control data is generated such that the picture brightness becomes double and supplied to the picture signal line drive unit 15 (step S44). If there is any picture signal of the following screen, processing is repeated from step S11 (step S15).

In the case where the histogram distribution T does not fall under in step S42, the counter shall be reset to zero (step S47). This means that when histogram distribution T no longer satisfies the conditions such as being equal to or less than ½, etc., the system immediately returns to the normal mode.

(Backlight Control of Multiple Stages)

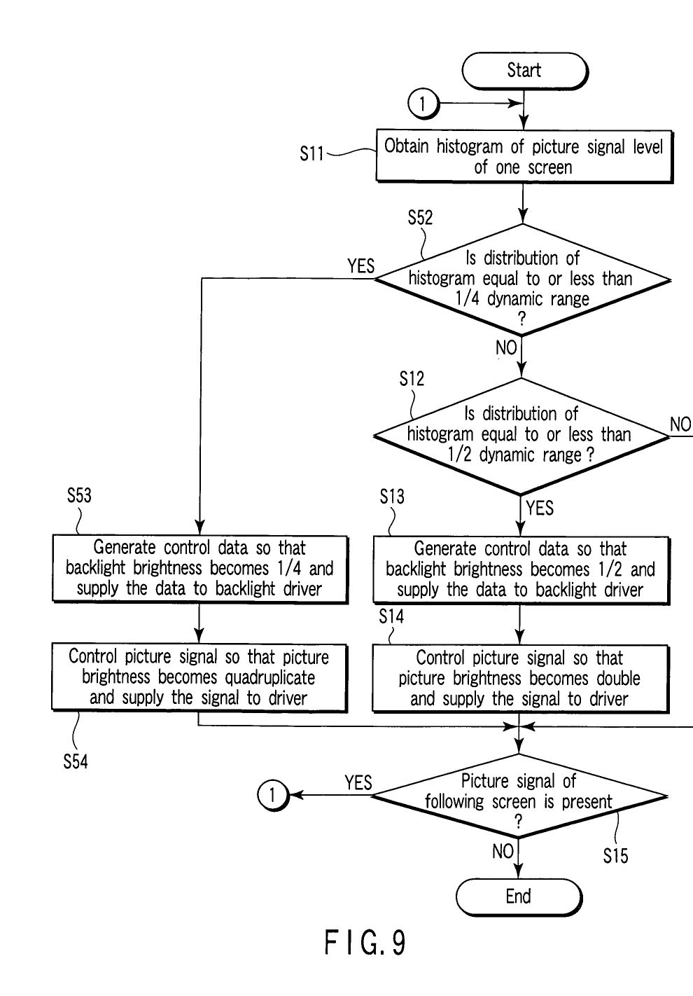

Furthermore, it is preferable to carry out not only ½ but also other ratio simultaneously in one processing program as shown in the flow chart of FIG. 9 in the ratio of the histogram distribution T to the dynamic range.

That is, as shown in the flow chart of FIG. 9, after finding a histogram (step S11), first, it is determined whether or not the histogram distribution T is equal to or less than ¼ the dynamic range (step S52). In the case where the histogram has such a value, control data in which the backlight brightness becomes ¼ is generated in the backlight light quantity control circuit 12, and the generated data is supplied to the backlight driver 13 (step S53). In addition, in the picture signal voltage level control circuit 12, control data is generated such that the picture brightness becomes quadruplicate and supplied to the picture signal line drive unit 15 (step S54). If there is any picture signal of the next screen, processing is repeated from step S11 (step S15).

However, even if this does not take place in step S52, it is determined whether or not the histogram distribution T is equal to or less than ½ the dynamic range (step S12). In the case where the histogram has such a value, control data which brings the backlight brightness to ½ is generated in the backlight light quantity control circuit 12, and the generated data is supplied to the backlight driver 13 (step S13). In addition, in the picture signal voltage level control circuit 12, control data is generated such that the picture brightness becomes double and supplied to picture signal line drive unit 15 (step S14). If there is any picture signal of the next screen, processing is repeated from step S11 (step S15).

In this way, by providing a plurality of processing that satisfy a plurality of conditions, ½, ¼, ⅛, and other processing are carried out continuously to achieve the high gradation property by carrying out optimum backlight control in accordance with the screen conditions.

(Combined Use of Error Diffusion Method or Dither Method)

Furthermore, in the embodiment of the present invention, in the case where histogram distribution T does not fall under the desired value, images are processed by using an error diffusion method or a dither method. That is, as shown in FIG. 3, in the case where the brightness distribution of the picture signal in one scan line covers substantially the whole region of the dynamic range, backlight control cannot be carried out, and therefore, lower-4-bit data is discarded. Inputting the data into the signal voltage driver loses fine gradations contained in the original picture signal and gives rise to nonconformity such as a level difference between gradations in the case where fine gradations, etc. exist.

Therefore, in the present invention, for picture signals of the brightness distribution in which backlight control cannot be carried out as shown in FIG. 3, multi-pseudogradation processing by error diffusion, dither process, etc. is carried out, and nonconformity as described above shall be suppressed. With respect to the error diffusion processing and dither method, many references are known. For the error diffusion, Jpn. Pat. Appln. KOKAI Publication No. 2004-361885, and for the diffuser method, “Practical Image Processing Leant in Language C” published by Ohmsha in 1999 are mentioned, but they shall not be limited to these documents.

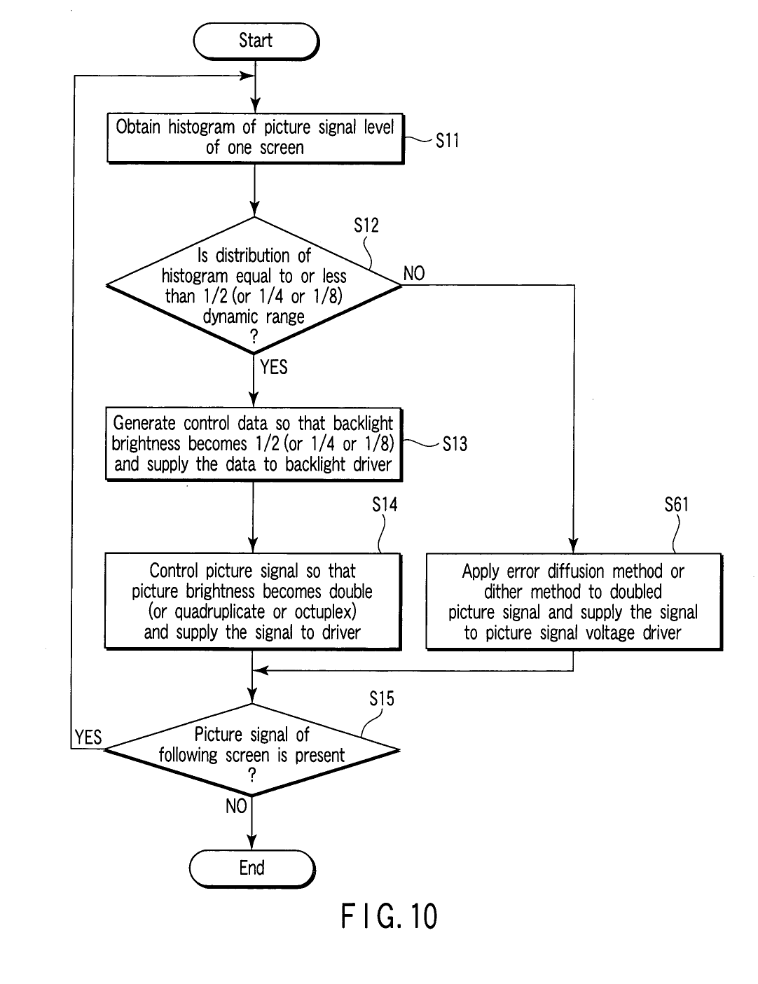

In step S61 of the flow chart of FIG. 10, processing by the error diffusion method or dither method is applied, whereby processing of multigradation by backlight control and multi-pseudogradation by error diffusion, etc. is appropriately carried out in accordance with the picture brightness distribution condition, so that still finer image display can be achieved.

In each of these above-mentioned embodiments, processing is explained for each screen. However, it is not always necessary to take this form, but it is preferable that the screen may be divided into 2 regions or 4 regions, and same processing is carried out for each divided screen. It is also preferable to carry out processing with the screen divided into four regions or more.

(Field Emission Display (FED) According to One Embodiment of the Present Invention)

Moreover, all the processing of each process described above can be applied not only to a liquid crystal display device but also to the FED shown in FIG. 4 in a completely equivalent manner, and the equivalent working-effects are generated.

Now, as shown in FIG. 4, a display device 1 using an FED has a picture signal level detection circuit 11, a control circuit 21, a scan line drive unit 14, a picture signal line drive unit 15, and an FED panel 22. The picture signal level detection circuit 11 generates histograms according to picture signals. The control circuit 21 carries out multi-pseudogradation processing, scan line driver voltage level control, and picture signal voltage level control. The scan line drive unit 14 receives the output and supplies scan line signals to the FED panel 22. The picture signal line drive unit 15 supplies display drive signals to an FED panel 17.

However, in the case of a light-emitting type matrix display such as a field emission display (FED), etc., a drive voltage of a scan driver of matrix is varied, whereby control is carried out on light-emitting brightness per unit time, in place of the backlight brightness correction processes (step S13, step S24, step S34, step S45, step S53) of each flow chart of FIGS. 5 to 10. With respect to the portion which corresponds to the signal line driver, the number of expressible gradations in a specific brightness region where picture signals are concentrated can be increased by linking a pulse modulation width and an amplitude value of a drive voltage to this. Consequently, each one of all the embodiments shown in each flow chart of FIGS. 5 to 10 can be applied to display devices using FED.

In the display device described above, a picture concentration histogram is generated in accordance with picture signals given. In the case where the brightness distribution from the minimum brightness of this histogram exists only in the region equal to or less than ½ the displayable dynamic range of the display screen, the gradation property cannot be fully displayed as it is and a merely dark screen as a whole is displayed. Therefore, lowering the brightness of the backlight, which is an irradiation unit, to, for example, ½ enables to double the picture signal voltage, which is a display drive signal in accordance with picture signals, in the case where the relation between the signal size and brightness is substantially linear. In addition, the picture signal voltage results in having double gradation property by fully making the best of the dynamic range of the display screen, and the high-gradation image display can be achieved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a display drive unit which generates a display drive signal that corresponds to a picture signal to be supplied;
a light-emitting drive unit which generates a light-emitting drive signal that corresponds to the picture signal to be supplied;
a display unit which displays images in accordance with the display drive signal from the display drive unit;
an irradiation unit which emits light in accordance with the light-emitting drive signal from the light-emitting drive unit and irradiates the display unit from behind;
a detection unit which converts a brightness distribution of the picture signal to be supplied into histograms; and
a control unit which compares a displayable bandwidth of the display unit with a bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controls the light-emitting drive signal so as to lower the degree of irradiation of the irradiation unit in accordance with the picture signal and controls the display drive signal so as to improve brightness of image display of the display unit in accordance with the picture signal.

2. The display device according to claim 1, wherein the control unit compares the displayable bandwidth of the display unit with the bandwidth from the minimum brightness of the brightness distribution posted to the histogram, and when the bandwidth from the minimum brightness of the brightness distribution posted to the histogram is ½ or less the displayable bandwidth of the display unit, controls the light-emitting drive signal so as to lower the brightness of the irradiation unit to ½ in accordance with the picture signal and controls the display drive signal so as to achieve double-improvement in brightness of image display of the display unit in accordance with the picture signal.

3. The display device according to claim 1, wherein the control unit compares the displayable bandwidth of the display unit with the bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controls the light-emitting drive signal so as to lower the degree of irradiation of the irradiation unit to ½ in accordance with the picture signal and controls the display drive signal so as to achieve double-improvement in brightness of image display of the display unit in accordance with the picture signal.

4. The display device according to claim 1, wherein the control unit receives signals that correspond to an indoor light quantity and controls the light-emitting drive signal and the display drive signal with these further taken into account.

5. The display device according to claim 1, wherein the control unit has a counter which compares the displayable bandwidth of the display unit with the bandwidth from the minimum brightness of the brightness distribution posted to the histogram and counts up when the bandwidth from the minimum brightness of the brightness distribution posted to the histogram is equal to or less than a predetermined of the displayable bandwidth of the display unit, and
when the number of counts reaches a predetermined number, the control unit controls the light-emitting signal so as to lower the degree of irradiation of the irradiation unit in accordance with the picture signal, and controls the display drive signal so as to improve brightness of image display of the display unit in accordance with the picture signal.

6. The display device according to claim 1, wherein the control unit compares the displayable bandwidth of the display unit with the bandwidth from the minimum brightness of the brightness distribution posted to the histogram, and when the bandwidth from the minimum brightness of the brightness distribution posted to the histogram is ¼ or less the displayable bandwidth of the display unit, controls the light-emitting drive signal so as to lower the brightness of the irradiation unit to ¼ in accordance with the picture signal and controls the display drive signal so as to achieve quadruplicate-improvement in brightness of image display of the display unit in accordance with the picture signal; and when the bandwidth from the minimum brightness of the brightness distribution posted to the histogram is ½ or less the displayable bandwidth of the display unit, controls the light-emitting drive signal so as to lower the brightness of the irradiation unit to ½ in accordance with the picture signal and controls the display drive signal so as to achieve double-improvement in brightness of image display of the display unit in accordance with the picture signal.

7. The display device according to claim 1, further comprising:
an error-diffusion processing unit which, when the control unit determines that the bandwidth from the minimum brightness of the brightness distribution posted to the histogram is not equal to or less than the predetermined ratio of the displayable bandwidth of the display unit, supplies the picture signal to be supplied to the display drive unit after applying error-diffusion processing to the picture signal to be supplied.

8. The display device according to claim 1, further comprising:
a dither-method processing unit which, when the control unit determines that the bandwidth from the minimum brightness of the brightness distribution posted to the histogram is not equal to or less than the predetermined ratio of the displayable bandwidth of the display unit, supplies the picture signal to be supplied to the display drive unit after applying dither-method processing to the picture signal to be supplied.

9. A display device comprising:
a display drive unit which generates a display drive signal that corresponds to a picture signal to be supplied;
a scan drive unit which generates a scan voltage which corresponds to the picture signal to be supplied;
a display unit which displays images by irradiating each pixel with light in accordance with the display drive signal from the display drive unit and the scan voltage from the scan drive unit;
a detection unit which converts a brightness distribution of the picture signal to be supplied into histograms; and
a control unit which compares a displayable bandwidth of the display unit with a bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controls so as to lower the scan voltage of the scan drive unit and controls to improve the display drive signal of the display drive unit.

10. A method for driving a display device comprising: a display unit which displays images by a display drive signal that corresponds to a picture signal; and an irradiation unit which irradiates the display unit from behind, the method comprising:
converting a brightness distribution of the picture signal to be supplied into histograms;
comparing a displayable bandwidth of the display unit with a bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controlling the light-emitting drive signal so as to lower the degree of irradiation of the irradiation unit in accordance with the picture signal, and controlling the display drive signal so as to improve the brightness of image display of the display unit in accordance with the picture signal.

11. The driving method according to claim 10, wherein the control compares the displayable bandwidth of the display unit with the bandwidth from the minimum brightness of the brightness distribution posted to the histogram, and when the bandwidth from the minimum brightness of the brightness distribution posted to the histogram is ½ or less the displayable bandwidth of the display unit, controls the light-emitting drive signal so as to lower brightness of the irradiation unit to ½ in accordance with the picture signal, and controls the display drive signal so as to achieve double-improvement in brightness of image display of the display unit in accordance with the picture signal.

12. The driving method according to claim 10, wherein the control compares the displayable bandwidth of the display unit with the bandwidth from the minimum brightness of the brightness distribution posted to the histogram, and when the bandwidth from the minimum brightness of the brightness distribution posted to the histogram is equal to or less than a predetermined ratio of the displayable bandwidth of the display unit, controls the light-emitting drive signal so as to lower the degree of irradiation of the irradiation unit to ½ in accordance with the picture signal, and controls the display drive signal so as to achieve double-improvement in brightness of image display of the display unit in accordance with the picture signal.

13. The driving method according to claim 10, wherein the control receives signals that correspond to an indoor light quantity and controls the light-emitting drive signal and the display drive signal with these further taken into account.

14. The driving method according to claim 10, wherein the control has a counter which compares the displayable bandwidth of the display unit with the bandwidth from the minimum brightness of the brightness distribution posted to the histogram and counts up when the bandwidth from the minimum brightness of the brightness distribution posted to the histogram is equal to or less than a predetermined ratio of the displayable bandwidth of the display unit, and when the number of counts reaches a predetermined number, controls the light-emitting signal so as to lower the degree of irradiation of the irradiation unit in accordance with the picture signal, and controls the display drive signal so as to improve brightness of image display of the display unit in accordance with the picture signal.

15. The driving method according to claim 10, wherein the control compares the displayable bandwidth of the display unit with the bandwidth from the minimum brightness of the brightness distribution posted to the histogram, and when the bandwidth from the minimum brightness of the brightness distribution posted to the histogram is ¼ or less the displayable bandwidth of the display unit, controls the light-emitting drive signal so as to lower the brightness of the irradiation unit to ¼ in accordance with the picture signal, and controls the display drive signal so as to achieve quadruplicate-improvement in brightness of image display of the display unit in accordance with the picture signal; and when the bandwidth from the minimum brightness of the brightness distribution posted to the histogram is ½ or less the displayable bandwidth of the display unit, controls the light-emitting drive signal so as to lower the brightness of the irradiation unit to ½ in accordance with the picture signal, and controls the display drive signal so as to achieve double-improvement in brightness of image display of the display unit in accordance with the picture signal.

16. The driving method according to claim 10, further comprising:
when it is determined, in the control, that the bandwidth from the minimum brightness of the brightness distribution posted to the histogram is not equal to or less than the predetermined ratio of the displayable bandwidth of the display unit, using the picture signal to be supplied as display after applying error-diffusion processing to the picture signal to be supplied.

17. The driving method according to claim 10, further comprising:
when it is determined, in the control, that the bandwidth from the minimum brightness of the brightness distribution posted to the histogram is not equal to or less than the predetermined ratio of the displayable bandwidth of the display unit, using the picture signal to be supplied as display after applying dither-method processing to the picture signal to be supplied.
